(19) United States
(12) Patent Application Publication
(10) Pub. No.: US 2021/0122185 A1
(43) Pub. Date: Apr. 29, 2021

(54) ANTI-SLIP TRACING INSTRUMENT

(71) Applicants: Abdelkader AINSEBA, Houilles (FR); Chakib GHAOUTA, Saugus, MA (US)

(72) Inventor: Abdelkader AINSEBA, Houilles (FR)

(21) Appl. No.: 17/140,030

(22) Filed: Jan. 1, 2021

Related U.S. Application Data
(63) Continuation-in-part of application No. PCT/FR20/00206, filed on Aug. 13, 2020.

(30) Foreign Application Priority Data
Jul. 12, 2019 (FR) FR1907878

(51) Int. Cl. B43L 12/00; G01C 9/00

(52) U.S. Cl. CPC B43L 12/00; G01C 9/00

(57) ABSTRACT

The tracing instrument, such as a ruler, set square or protractor, includes a main body with one or more lateral tracing elements. The tracing instrument includes sliding systems and gripping systems. The sliding systems include displacement devices chosen from among translation, rotation, deformation with respect to the main body and devices to facilitate movement/displacement of the tracing instrument. The tracing instrument can be made in several blocks. The main body associated with the gripping systems and the lateral tracing elements associated with the sliding systems are separated blocks. The main body is operable by pressing to perform a gripping. The tracing instrument can be for the school environment, in particular for children suffering from dyspraxia, however it can be extended to other uses.

### CROSS-REFERENCE TO RELATED APPLICATIONS

The present application claims priority under 35 U.S.C. Section 120 from PCT Application Serial No. PCT/FR20/00206, filed on 13 Aug. 2020, entitled “ANTI-SLIP TRACING INSTRUMENT”. See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of tracing, such as a ruler, set square or protractor. In particular, such a device can be a tracing instrument in the “educational materials” category or in the work category or even in the field of creativity, making it possible to trace or cut any kind of material, but not only. The general aim of the invention is to provide a tracing/cutting instrument capable of moving easily on the surface of a material, then at the desired moment having very strong adhesion to the support.

### 2. Description of Related Art Including Information Disclosed Under 37 CFR 1.97 and 37 CFR 1.98

In the school environment, there are the rulers of transparent plexiglass, being cheap and offering an exceptional glide on a sheet of paper. Also, these rulers have the advantage of being pressed against the sheet of paper, so that the lower surface of the ruler body and the surface of the sheet of paper match perfectly at all points, thus resulting in perfect stability. Therefore, no play is created under the edges of the lateral tracing sides. This makes it possible to draw easily and to have a fair and precise tracing. However, this comfort consisting in moving the ruler easily, presents a drawback at the time of the drawing, called “the sliding accident”.

There are techniques for making tracing instruments with a certain grip in order to compensate for “sliding accidents” when tracing. For example, metal rulers with a rubber material in the form of a strip to create an eye-catcher with the sheet of paper. There are also the plastic rulers with non-slip material distributed under the ruler body, resembling suction cups, in order to provide a solution of comfort, mainly to children with difficulties in coordinating movements, such as dyspraxia for example.

In the school environment or creativity environment, the user with a pencil in one hand, and handling the tracing instrument with the other hand, needs to bring together the best conditions to facilitate concentration to let go of his imagination. In other words, nothing should interfere with this comfortable mental disposition. Whatever the inconvenience caused, it influences thinking, and therefore slows down thinking, and therefore speed of execution. This is why the usefulness of having a tracing instrument capable of moving easily is essential since by extension and by mental projection, the ease of moving our hands promotes thinking, and therefore actions. Then, at another time, the user, ready to trace or cut, needs to stabilize the tracing instrument in translation, to ensure the trace or cut. In other words, it's all about timing!

Therefore, the use of anti-slip rulers is not fully satisfactory, since their characteristic anti-slip property, considered an advantage when drawing to prevent the ruler from moving, becomes a disadvantage when the user moves the ruler. Moreover, in the realization of the anti-slip rulers, because of their structure and their design, the anti-slip system outweighs the displacement, that is to say that the anti-slip material is in first contact with the support. This is why the movement of the ruler on the surface of the support is slowed down. As a result, the tracing instrument stuck in the inertia of its movement, forcing the user to push harder on the layout instrument, creating jerky movements, which impedes accuracy and reliability. Thus, the movement of the tracing instrument is constrained, making it very difficult to grip.

To reduce this discomfort, the user is obliged to “take off” one of the sides of the ruler from the support, that is to say, lift and then position the ruler at an angle with respect to the plane of the support, in order to reduce the friction caused by non-slipping properties, and finally find a relative convenience in movement, more or less satisfactory.

On the other hand, because of their design, when the tracing instrument is placed flat on the support to be traced, the non-slip material, making contact first with the support to be traced, raises the ruler body relative to the plane of the support to be traced. Thus, a gap is created under the edges of the lateral tracing sides. As a result, on the one hand, the pencil can accidentally get lodged under the hollow and distort the line. On the other hand, because of the vacuum, the ruler not pressing at any point on the surface of the support to be traced, creates an imbalance or an instability, causing a rotational play along the X axis FIG. 1, which ultimately produces a loose ruler.

In short, the higher the “non-slip” properties, the more there is a loss in fluidity of movement. In other words, the handling of geometry tools becomes difficult/complicated.

Finally, the anti-slip rulers are mainly focused on making plots on school materials, i.e. sheets of paper, so their use is limited.

For non-limiting example, in the field of “DIY” including applications such as creativity, work of all kinds, or decoration, it is essential when tracing/cutting to have a ruler with properties of high adhesions in order to avoid sliding accidents. This is why it is essential to secure the cut. The various known techniques do not make it possible to have a tracing instrument which admits very good fluidity during movement, allowing adjustment and precision of the layout and very good grip, whatever the medium, at the time of the route.

Another use is particularly intended in the school environment, in particular for children suffering from dyspraxia. Indeed, this tracing instrument refines the gesture and increases confidence for those who have difficulty automating hand gestures in time and space. There is a need in this.

### BRIEF SUMMARY OF THE INVENTION

The present invention aims to remedy all of the previously exposed drawbacks; it aims to provide another tracing solution.

To this end, the invention comprises a main body (and its lateral tracing elements) consisting, on the upper face, of a graduation of known type, and on the lower face, of systems making it possible to facilitate movement, called “sliding system” and systems for blocking, called “grip system”, that is to say non-slip.

The general idea is to have two interdependent systems, which intuitively allow you to act as needed [move, measure, trace, cut].

When the tracing instrument is placed on the surface of a material where it is to act, it is assumed that it can be handled/moved with one hand without detaching it from the support, i.e. ie by dragging it. This is why the “sliding system” is prioritized first, and then at the appropriate time, by pressure exerted above the main body, to activate the “grip system”. In other words, the tracing instrument is by default free and fluid in movement, then when it is decided, the tracing instrument is blocked/immobilized in order to ensure the tracing/cutting, that is to say without risk accident, called skidding.

In one aspect, the invention provides for separating a main body block operable by pressing down for grip, and a block of lateral tracing elements allowing sliding.

Advantageously, the lateral tracing elements remain in the low position near the support, which results in more precision in the tracing or cutting, and prevents a pencil or a blade from being stuck between the tracing element and the support during handling the instrument.

Thus, the invention concerns a tracing instrument, such as a ruler, set square or protractor comprising a main body with one or more lateral tracing elements, the tracing instrument being provided on the lower part, of one or more sliding systems and one or more gripping systems, in which the sliding systems comprise displacement means chosen from among translation, rotation, deformation with respect to the main body and means intended to facilitate movement/displacement of the tracing instrument, characterized in that the tracing instrument is made in several blocks, the main body associated with the gripping system (s) and the lateral tracing elements associated with the sliding system (s) are separated blocks, and in that the main body is operable by pressing to perform a gripping.

According to further aspects of the invention taken separately or combined according to any technically feasible combination:

the lateral tracing elements act as a sliding system or comprise the sliding system; and/or

the main body is joined together with the lateral tracing elements by means of the fixing system which, by pressure exerted above the main body, allows to operate a translational movement from top to bottom, and when the pressure is released allows to operate a translational movement from bottom to top; and/or

the gripping system comprises means intended to adhere to all kinds of supports making it possible to prevent slipping, the adhesion being realized by the shape of the means and/or by the material, the surface of the gripping system can occupy part or all of the surface of the lower part of the main body; and/or

the sliding system comprises a ball bearing device, preferably provided with a multidirectional ball the ball bearing device being optionally retractable; and/or

the main body and/or the lateral tracing elements have orifices in which fingers of the lateral tracing elements are inserted and/or of the body cooperating with said orifices; and/or

on the outside of the fingers return means, in particular compression springs, are arranged so as to allow the main body to be retracted; and/or

the fixing means of the fixing system are sliding linkages coupled with one or the compression spring; and/or

adjacent/vertical sides of the lateral tracing elements have a height greater than the height of the main body; and/or

the tracing instrument comprises a handle associated with the main body, configured to distribute a bearing pressure along the main body; and/or

the lateral tracing elements form a tracing block having an upper hole receiving the main body, and a lower hole allowing the gripping system to pass through; and/or

the main body comprises a body ledge, preferably close to the upper hole, and the tracing block comprises an upper tracing ledge, preferably close to the upper hole, forming a translation stop for the body upwards; and/or

the tracing instrument comprises a return means for said upward translation; and/or

the return means comprises at least one spring blade preferably in “Z-form”; and/or

the main body comprises one or said body ledge, preferably close to the lower hole, and the tracing block comprises in addition a lower tracing ledge, forming a support for said return means; and/or

the main body is in multiple parts; and/or

the tracing instrument comprises a pivotable handle; and/or

the tracing instrument comprises a level indicator, preferably a bubble leveller.

### BRIEF DESCRIPTION OF THE SEVERAL VIEWS OF THE DRAWINGS

The invention and its advantages will be better understood with the aid of the following description, with reference to the accompanying schematic drawings, showing, as an example, one way of executing this tracing instrument (two embodiments).

Although the present invention has been described with reference to specific working examples, it is obvious that modifications and changes can be made to these examples without departing from the general scope of the invention as defined by the claims. In particular, the different embodiments illustrated/mentioned can be combined in additional embodiments. Therefore, the description and the drawings should be considered in an illustrative rather than restrictive sense. In other words, they are not limitative of the invention. They only represent embodiments of the invention and will allow it to be easily understood. FIGS. 1 to 9 represent the first embodiment:

FIG. 1 shows an elevation view of a sliding system suitable for certain variants of the invention.

FIG. 2 is a bottom plan view of the sliding system.

FIG. 3 is a perspective view of the sliding system, illustrating the stop.

FIGS. 4 to 6 show a first embodiment:

FIG. 4 shows a perspective view of the tracing instrument.

FIG. 5 shows a side elevation view of the tracing instrument with an “activated” sliding system.

FIG. 6 shows another side elevation view, illustrating the tracing instrument with an “activated” gripping system.

FIG. 7 is a schematic view illustrating lateral tracing elements of an instrument according to a variant of the first embodiment.

FIG. 8 is a top plan view illustrating said lateral tracing elements.

FIG. 9 is a side elevation view illustrating a main body corresponding to the side tracing elements of FIGS. 7 and 8.

FIG. 10 is a schematic view illustrating an instrument according to another variant of the first embodiment in a front view with the main body raised.

FIG. 11 is a schematic view illustrating the instrument of FIG. 10 with the main body lowered.

FIG. 12 is a schematic view illustrating an instrument according to another variant of the first embodiment in a side view with a handle.

FIG. 13 is a perspective view illustrating an instrument according to a second embodiment.

FIG. 14 is a longitudinal sectional view of the instrument of FIG. 13.

FIG. 15 is a schematic view illustrating an embodiment that is alternative to the one of FIG. 12, in which the main body is in multiple parts.

FIG. 16 is a schematic view illustrating an embodiment that is alternative to the ones of FIGS. 12 and 15, in which both the main body and the gripping system are in multiple parts.

FIG. 17 is a side elevation view of another embodiment with a handle, wherein the handle is pivotable.

FIG. 18 is a side elevation view of the embodiment of FIG. 17, wherein the handle is pivoted.

FIG. 19 is a top plan view of the embodiment of FIGS. 17 and 18.

FIG. 20 is another top plan view of an embodiment further comprising a level indicator.

### DETAILED DESCRIPTION OF THE INVENTION

The tracing instrument (10), is achieved, in particular by determining the arrangement of the two—sliding (14, 15) and gripping (16)—systems, so that they interact together in a coherent and harmonious way. Indeed, without this being limiting, two possible configurations are detailed in this document.

Whatever configuration being chosen, in general, the tracing instrument (10) comprises a main body (12) with one or more lateral tracing elements.

The shape and dimensions of the main body (12) and of the lateral tracing elements are such as to fulfill the function of a tracing instrument (10). On the upper part of the main body (12), a known type of graduation can be placed.

The tracing instrument (10) is provided on the lower part of the main body (12) with one or more sliding systems (14, 15) and one or more gripping systems (16).

The sliding systems (14, 15) include displacement means chosen from translation, rotation, deformation with respect to the main body (12). In addition, the sliding system (14, 15) comprises means intended to facilitate the movement/displacement of the tracing instrument (10). Thus, when the tracing instrument (10) is placed flat on the support (30) of the object to be traced, according to the tracing plane (X, Y), a fluid, linear movement without interference is obtained.

The gripping system (16) comprises means intended to adhere to all kinds of supports making it possible to avoid slipping, the gripping being achieved by the shape of the means and/or by the material. The means are in the form of a structure, of non-slip material such as rubber or the like. In other words, the gripping system (16) has a “blocking” function in order to immobilize the tracing instrument (10) in translation, according to the plane (X, Y) at the decided moment.

Depending on the nature of the object to be traced, the shape, dimensions, structure and material of the gripping system (16) are such as to fulfill the function of anti-slip. Also, the surface of the gripping system (16) in contact with the surface of the object to be traced, can occupy part or all of the surface, of the lower part of the main body (12).

First Configuration

The idea is to achieve a first possible design, i.e. another form of tracing instrument (10) while keeping the same principle and therefore the same result, i.e. using in priority and by default the sliding system (14, 15), then when desired “activate” the gripping system (16).

For this configuration, the tracing instrument (10) is made in several blocks, the main body (12) and the lateral tracing elements (22) are separate blocks.

In this example, the tracing instrument (10) comprises a main body (12) and two lateral tracing elements (22) arranged on either side, along the main body (12) along the X axis, shown in FIG. 10.

The tracing instrument (10) is provided with one or more sliding systems (14, 15) and one or more gripping systems (16).

The lower part of the main body (12) is fitted with gripping systems (16). Depending on the nature of the object where the line is drawn, the shape, dimensions, structure and material of the gripping system (16) are such as to fulfill the function of non-slipping. The gripping system (16) is connected to the main body (12) in a permanent or removable manner.

Due to their shape, structure, design, and material, the lateral tracing elements (22) act as a sliding system (15), they include means intended to facilitate the movement of the tracing instrument (10). This is, for example, a material of lateral tracing elements (22) allowing the tracing instrument (10) to slide on its support or a specific coating for this purpose.

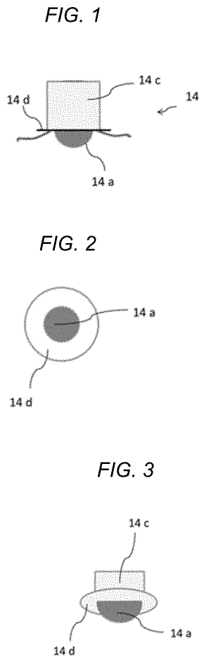

In a variant, it is possible to envisage sliding by rolling by means of ball bearings (14) such as those of FIGS. 1 to 3 distributed over the lateral tracing elements. This is for example a ball bearing device (14c) preferably equipped with a multidirectional ball (14a) per bearing. The device (14c) may include a fixing ledge (14d) to the lateral tracing elements (22). One can envision a retractable device with balls which fit inside the outer surface of the tracing instrument (10).

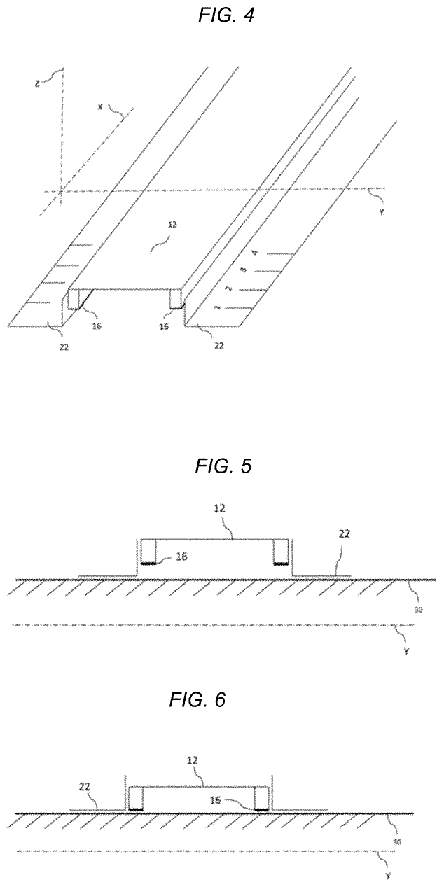

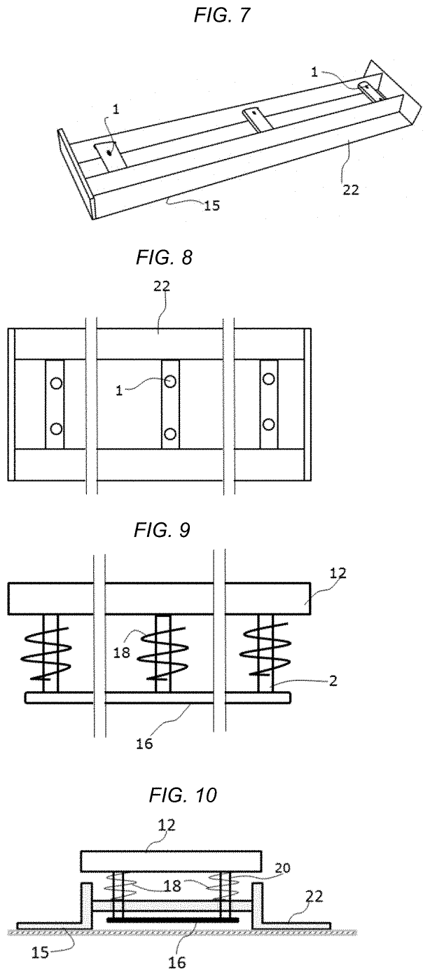

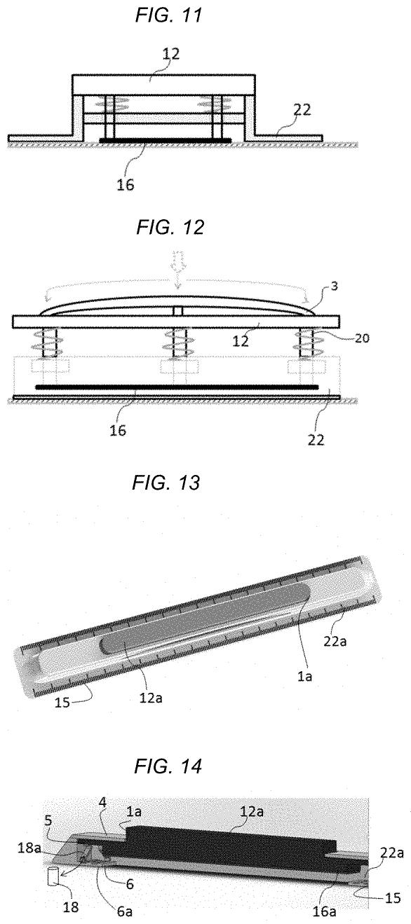

FIG. 4 illustrates one aspect of lateral tracing elements (22), which, by virtue of their material and their “ski”-shaped structure, play the role of “sliding system”.

In order to further optimize the sliding system (15) of the tracing instrument (10), the area of the lower part of the lateral tracing elements (22) is as large as possible.

Concerning the sliding on the support, the main body (12) is secured to the lateral tracing elements (22) to the means of fixing systems which, by pressure exerted above the main body (12), makes it possible to operate a translational movement from top to bottom, and when the pressure is released makes it possible to operate a translational movement from the bottom to the top. The fixing means are preferably made by a sliding linkage coupled with a compression spring (18), this allows the main body (12) to move vertically along the plane (Y, Z) FIG. 4, with respect to the lateral tracing elements (22), from top to bottom and vice versa.

The sliding linkage comprises, for example, fingers (20) associated with orifices (1) and return means, in particular the spring (18) making it possible to retract the main body (12).

In the preferred variant, the main body (12) comprises said fingers (20), and the lateral tracing elements (22) comprise said orifices (1), but a reverse arrangement can be envisaged.

The lower surface of the lateral tracing elements (22) in first contact with the support (30), serves as a support allowing the main body (12), thus the main body (12) can move in translation from the top to the bottom and vice versa.

Also, thanks to a pressure exerted above the main body (12), the main body (12) “descends” [the spring compresses] and places the surface of the gripping system (16) on the surface of the support (30). Thus, the gripping system (16) is “activated” and operates the anti-slipping function.

By releasing the pressure exerted on the main body (12) [the spring releases] then, the main body (12) returns to its initial position. As a result, the “activated” sliding system regains its priority position. FIGS. 5 and 6 illustrate the vertical translational movement of the lateral tracing elements (22).

The adjacent/vertical sides of the lateral tracing elements (22), perpendicular to the Y axis shown in FIG. 6, have a height greater than the height of the main body (12) to protect the fingers during cuttings.

In a preferred variant, the tracing instrument (10) further comprises a handle (3) associated with the main body, configured to distribute a pressing pressure along the main body (12). The handle (3) may be translatable.

Second Configuration

In another embodiment, the tracing instrument (10a) is similar to the previous one but is characterized by lateral tracing elements (22a) forming a tracing block having an upper hole (1a) receiving the main body (12a), and a lower hole (6) allowing the gripping system (16a) of the main body (12a) to pass.

This configuration can be illustrated by FIGS. 13 and 14.

The main body (12a) can be longitudinal and cylindrical and the corresponding hole (1a) is therefore substantially oval.

Alternatively, the main body (12a) comprises a body ledge (5), preferably close to the upper hole (1a), and the tracing block comprises an upper tracing ledge (4), preferably close to the upper hole (1a). The upper tracing ledge (4) forms a stop for the upward translation of the body (12), in particular in cooperation with the body ledge (5).

According to a variant, the tracing instrument (10a) comprises a return means for said upward translation. In the illustrated variant, the return means comprises at least one leaf spring (18a) preferably in “Z-form”. Of course, it is also possible to consider using a compression spring (18) as a return means.

According to one variant, the tracing block further comprises a lower tracing ledge (6a), forming a support for said return means (18a). The main body (12a) may comprise another body ledge, preferably close to the lower hole (6), but said ledge (4) is used as an upper support for said return means in the illustrated variant.

The return means (18 or 18a) are preferably even and on either side of the main body (12a), in particular in a longitudinal direction. For more stability, the return means are two “Z” blades on each side of the main body (12a) as shown in FIG. 14.

According to a variant, the tracing instrument (10) is characterized by a mechanism for locking the main body (12, 12a) in the pressed position, in particular via a cam and stop mechanism. This type of mechanism can be adapted from that of a pen button with a retractable tip.

In a first configuration, said cam and said stopper can be arranged at the level of the sliding linkage.

In a second configuration, the cam and the stopper can be on two sides of the main body in the longitudinal direction or in the transverse direction.

Further Configurations

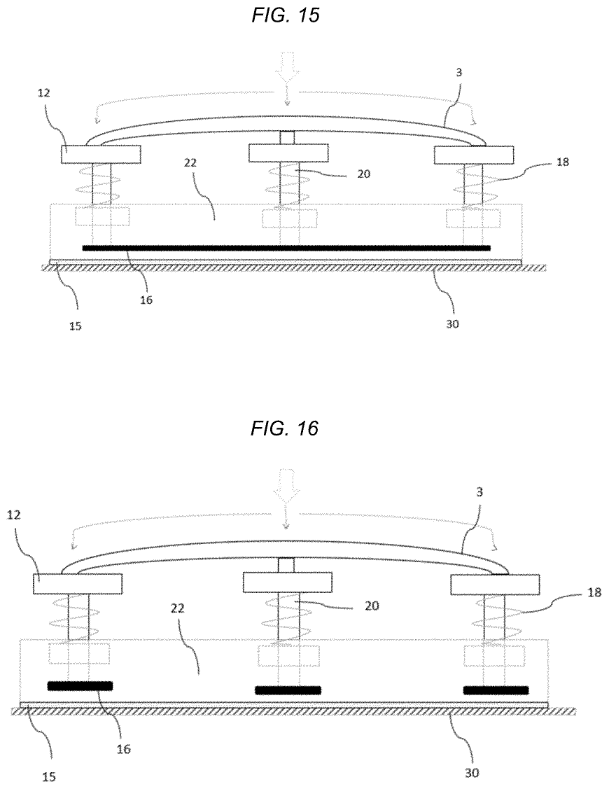

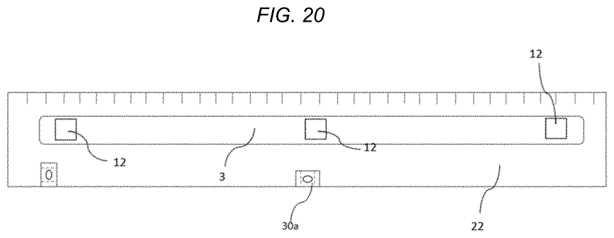

In further configurations that may be illustrated by FIGS. 15 to 20, the main body 12 is in multiple parts. The main body 12 may have for example two or three parts as illustrated in FIG. 15. Furthermore, the gripping system may comprise corresponding multiple parts as illustrated in FIG. 16.

Advantageously, having a main body 12 in two parts is enough to enable to an efficient and stable pressing support with a limited material for the main body 12. The same is true for the gripping system. The parts may be distributed along the tracing instrument.

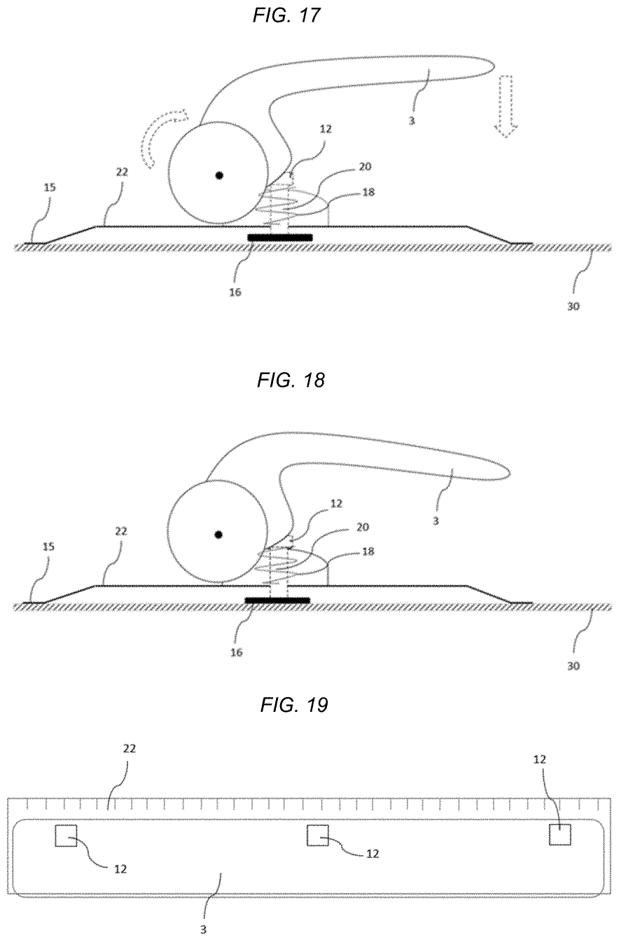

In further configurations, the tracing instrument comprises one or more pivotable handle 3. In the illustrated embodiment, the handle 3 is pivotally mounted about an axis that is parallel to the tracing instrument. The handle is pivoted to actuate the gripping systems 16. This embodiment may be illustrated by FIGS. 17 and 18.

In further configurations, the tracing instrument comprises one or more level indicator 30a. The level indicator 30a is preferably a bubble leveller. Thus, the invention enables to trace or cut according to a levelled line avoiding any slipping of the tracing instrument.

I claim:

1. A tracing instrument, comprising:
a main body with one or more lateral tracing elements,
the tracing instrument being provided on the lower part, of one or more sliding systems, and
one or more gripping systems,
wherein the sliding systems comprise displacement means chosen from among translation, rotation, deformation with respect to the main body and means intended to facilitate movement/displacement of the tracing instrument,
wherein the tracing instrument is made in several blocks,
wherein the main body associated with the gripping systems and the lateral tracing elements associated with the sliding systems are separated blocks, and
wherein the main body is operable by pressing to perform a gripping.

2. The tracing instrument, according to the claim 1, wherein the lateral tracing elements act as a sliding system or comprise the sliding system.

3. The tracing instrument, according to claim 1, wherein the main body is joined together with the lateral tracing elements by the fixing system which, by pressure exerted above the main body, allows to operate a translational movement from top to bottom, and when the pressure is released allows to operate a translational movement from bottom to top.

4. The tracing instrument, according to claim 1, wherein the gripping system comprises means intended to adhere to all kinds of supports making it possible to prevent slipping, the adhesion being realized by the shape of the means and/or by the material, the surface of the gripping system can occupy part or all of the surface of the lower part of the main body.

5. The tracing instrument, according to claim 1, wherein the sliding system comprises a ball bearing device provided with a multidirectional ball.

6. The tracing instrument, according to claim 1, wherein the main body and/or the lateral tracing elements have orifices in which fingers of the lateral tracing elements are inserted and/or of the body cooperating with said orifices.

7. The tracing instrument, according to claim 6, wherein on the outside of the fingers return means, compression springs, are arranged so as to allow the main body to be retracted.

8. The tracing instrument, according to claim 1, wherein the fixing means of the fixing system are sliding linkages coupled with one or the compression spring.

9. The tracing instrument, according to claim 1, wherein adjacent/vertical sides of the lateral tracing elements have a height greater than the height of the main body.

10. The tracing instrument, according to claim 1, further comprising: a handle associated with the main body, configured to distribute a bearing pressure along the main body.

11. The tracing instrument, according to claim 1, wherein the lateral tracing elements form a tracing block having an upper hole receiving the main body, and a lower hole allowing the gripping system to pass through.

12. The tracing instrument, according to claim 11, wherein the main body comprises a body ledge, close to the upper hole, and the tracing block comprises an upper tracing ledge, close to the upper hole, forming a translation stop for the body upwards.

13. The tracing instrument, according to claim 12, further comprising: a return means for said upward translation.

14. The tracing instrument, according to claim 13, wherein the return means comprises at least one spring blade in “Z-form”.

15. The tracing instrument, according to claim 13, wherein the main body comprises one or said body ledge, close to the lower hole, and the tracing block comprises in addition a lower tracing ledge, forming a support for said return means.

16. The tracing instrument, according to claim 1, further comprising: a mechanism for locking the main body in the pressed position, in particular via a cam and stop mechanism.

17. The tracing instrument, according to claim 1, wherein, in an initial position, the lower surface of the lateral tracing elements in first contact with the support, and wherein the main body and gripping systems are retracted above the support.

18. The tracing instrument, according to claim 1, wherein the main body is in multiple parts.

19. The tracing instrument, according to claim 1, further comprising: a level indicator.

20. The tracing instrument according to claim 1, wherein the sliding system is useable by default and in priority, and wherein the gripping system is useable when activated.
